(19) United States
(12) Patent Application Publication
(10) Pub. No.: US 2026/0125026 A1
(43) Pub. Date: May 7, 2026

(54) COMBINATION LOCKING WEB RETRACTOR AND ATTENUATOR

(71) Applicant: INDIANA MILLS & MANUFACTURING, INC., Westfield, IN (US)

(72) Inventors: Esaul Garcia Herrera, Saltillo (MX); Douglass W. Bittner, Indianapolis, IN (US); Scott R. Latuszek, Pittsboro, IN (US)

(21) Appl. No.: 19/349,705

(22) Filed: Oct. 3, 2025

Related U.S. Application Data
(60) Provisional application No. 63/717,466, filed on Nov. 7, 2024.

(51) Int. Cl. B60R 22/34

(52) U.S. Cl. CPC B60R 22/341; B60R 2022/3402

(57) ABSTRACT

A combination locking web retractor and web attenuator includes a locking web retractor having a first frame, a web, means for taking up and paying out web from the first frame, and means for locking the web retractor to prevent pay out of the web from the first frame, and a web attenuator including a second frame mounted to or integral with the first frame and carrying a movable web guide supporting the web passing from the web retractor through the web attenuator, and at least one biasing or resilient member coupled between the movable web guide and the first or second frame, the at least one biasing member applying a biasing force to the web guide opposite a load force applied by the web to the web guide with the retractor locked so as to resiliently attenuate the load force applied by the web to the web guide.

### CROSS-REFERENCE TO RELATED APPLICATION

This patent application claims the benefit of and priority to Provisional Ser. No. 63/717,466 , filed Nov. 7, 2024, the disclosure of which is expressly incorporated herein by reference in its entirety.

### TECHNICAL FIELD

The present disclosure relates generally to locking web retractors, and more specifically to a combination locking web retractor and web attenuator.

### BACKGROUND

Locking web retractors may typically be implemented in occupant restraint systems of motor vehicles and other transportation vehicles. A conventional locking web retractor may include a spool assembly having a spool upon which a web or belt is wound, and may be configured to take up web on the spool as the spool rotates in a web take-up direction, i.e., to take up web into the retractor, and to pay off the web from the spool as the spool rotates in an opposite web payout direction, i.e., to pay out web from the retractor. Conventional locking web retractors further include one or more conventional locking apparatuses configured to selectively lock and unlock, i.e., to prevent web from being paid out of the web retractor and to allow web to be paid out of the web retractor, respectively. Conventional web attenuators are typically mounted to the motor vehicle seat or to a structure within the motor vehicle, and typically operate on a portion of the web that is remote from the web retractor to attenuate forces applied to the web by the occupant during operation of the motor vehicle. It may be desirable in some implementations combine a locking web retractor and a web attenuator.

### SUMMARY

The present disclosure may comprise one or more of the features recited in the attached claims, and/or one or more of the following features and combinations thereof. In one aspect, a combination locking web retractor and web attenuator, may comprise a locking web retractor including a first frame, a web, means for taking up and paying out web from the first frame, and means for locking the web retractor to prevent pay out of the web from the first frame, and a web attenuator including: a second frame mounted to or integral with the first frame, the second frame defining a web entrance configured to receive the web from the locking web retractor and a web exit through which the web exits the second frame, a first web guide carried by, and movable relative to, the second frame, the first web guide configured to support the web between the web entrance and the web exit, and at least one biasing member coupled between the first web guide and at least one of the first or second frame, the at least one biasing member configured to apply a biasing force to the first web guide opposite a load force applied by the web to the first web guide with the web retractor locked so as to resiliently attenuate the load force applied by the web to the first web guide.

In another aspect, a combination locking web retractor and web attenuator may comprise a locking web retractor including a first frame, a web, means for taking up and paying out web from the first frame, and means for locking the web retractor to prevent pay out of the web from the first frame, and a web attenuator including: a second frame mounted to or integral with the first frame, the second frame receiving the web from the locking web retractor and defining a web exit through which the web exits the second frame, first and second web guides coupled to one another and carried by the second frame such that the first and second web guides are movable together relative to, the second frame, the first and second web guides each configured to support the web between the web entrance and the web exit, and at least one biasing member coupled between the first web guide and at least one of the first or second frame, the at least one biasing member configured to apply a biasing force to the first and second webs guide opposite a load force applied by the web to the first web guide with the web retractor locked so as to resiliently attenuate the load force applied by the web to the first and second web guides.

### BRIEF DESCRIPTION OF THE DRAWINGS

FIG. 1 is a rear perspective view of an embodiment of a combination locking web retractor and web attenuator showing the locking web retractor in a locked state.

FIG. 2 is a front perspective view of the combination locking web retractor and web attenuator of FIG. 1 showing the combination with the locking web retractor locked and with no tension greater than the biasing force of the web attenuator applied to the web.

FIG. 3 is a cross-sectional view of the combination locking web retractor and web attenuator of FIGS. 1 and 2, as viewed along section lines A-A of FIG. 1, with the locking web retractor locked and with no tension greater than the biasing force of the web attenuator applied to the web as depicted in FIG. 2.

FIG. 4 is another front perspective of the combination locking web retractor and web attenuator of FIGS. 1-3 showing the combination with the locking web retractor locked and with tension greater than the biasing force of the web attenuator applied to the web so as to fully load the web attenuator.

FIG. 5 is another cross-sectional view of the combination locking web retractor and web attenuator of FIGS. 1-4, as viewed along section lines A-A of FIG. 1, with the locking web retractor locked and with tension greater than the biasing force of the web attenuator applied to the web, as depicted in FIG. 4, so as to fully load the web attenuator.

FIG. 6 is a rear perspective view of another embodiment of a combination locking web retractor and web attenuator showing the locking web retractor in a locked state.

FIG. 7 is a front perspective view of the combination locking web retractor and web attenuator of FIG. 6 showing the combination without a web in the locking web retractor or the web attenuator so as not to obscure details of the web attenuator.

FIG. 8 is another front perspective view of the combination locking web retractor and web attenuator of FIGS. 6 and 7 showing the combination with the locking web retractor locked and with no tension greater than the biasing force of the web attenuator applied to the web.

FIG. 9 is yet another front perspective view of the combination locking web retractor and web attenuator of FIGS. 6-8 showing the combination with the locking web retractor locked and with tension greater than the biasing force of the web attenuator applied to the web so as to fully load the web attenuator.

FIG. 10 is a rear perspective view of yet another embodiment of a combination locking web retractor and web attenuator showing the locking web retractor in a locked state.

FIG. 11 is a front perspective view of the combination locking web retractor and web attenuator of FIG. 10 showing the combination with the locking web retractor locked and with no tension greater than the biasing force of the web attenuator applied to the web.

FIG. 12 is a cross-sectional view of the combination locking web retractor and web attenuator of FIG. 11, as viewed along section lines B-B of FIG. 10, showing the locking web retractor locked and with no tension greater than the biasing force of the web attenuator applied to the web as depicted in FIG. 11.

FIG. 13 is another front perspective view of the combination locking web retractor and web attenuator of FIG. 10 showing the combination with the locking web retractor locked and with tension greater than the biasing force of the web attenuator applied to the web so as to partially load the web attenuator.

FIG. 14 is a cross-sectional view of the combination locking web retractor and web attenuator of FIG. 13, as viewed along section lines B-B of FIG. 10, showing the locking web retractor locked and with tension greater than the biasing force of the web attenuator applied to the web so as to partially load the web attenuator as depicted in FIG. 13.

FIG. 15 is yet another front perspective view of the combination locking web retractor and web attenuator of FIG. 10 showing the combination with the locking web retractor locked and with tension greater than the biasing force of the web attenuator applied to the web so as to fully load the web attenuator.

FIG. 16 is a cross-sectional view of the combination locking web retractor and web attenuator of FIG. 15, as viewed along section lines B-B of FIG. 10, showing the locking web retractor locked and with tension greater than the biasing force of the web attenuator applied to the web so as to fully load the web attenuator as depicted in FIG. 15.

### DESCRIPTION OF THE ILLUSTRATIVE EMBODIMENTS

For the purposes of promoting an understanding of the principles of this disclosure, reference will now be made to a number of illustrative embodiments shown in the attached drawings and specific language will be used to describe the same.

This disclosure relates to various embodiments of a combination locking web retractor and web attenuator, in which various embodiments of a web attenuator are mounted to or integral with various embodiments of a locking web retractor. In this regard, it will be understood that while some example embodiments of locking web retractors are illustrated by example in the attached figures, this disclosure is not limited to any particular type or style of locking web retractor and/or to any particular structure for locking and unlocking the web retractor, i.e., “locked” to prevent web from being paid out of the web retractor, and “unlocked” to allow web to be paid out of the retractor, and the locking web retractor combined with any embodiment of the web attenuator may accordingly be any conventional locking web retractor without limitation. In some embodiments, the locking web retractor may be an inertial locking web retractor of any type and operable to automatically lock the web retractor in response to an inertial event in excess of an inertial threshold. Alternatively, the web retractor may be a manual locking retractor; that is, the web retractor may be locked manually, i.e., by manually actuating at least one locking component of the web retractor. In some such embodiments, the web retractor may be a ratcheting web retractor; that is, the web retractor may include a handle or lever configured to be manually actuated to incrementally rotate, i.e., ratchet, a spool shaft so as to incrementally take up web onto a spool when the web retractor is locked. In any case, example locking web retractors that may be implemented with a combination locking web retractor and web attenuator as described herein may be or include, but are not limited to, emergency locking retractors (ELRs), automatic locking retractors (ALRs), web-sensitive locking retractors, vehicle-sensitive locking retractors, combination web-sensitive and vehicle-sensitive locking retractors, sealed web retractors, heavy-duty web retractors, medium-duty web retractors, light-duty web retractors, ratcheting web retractors, and the like.

The locking web retractor, however embodied, will typically define or be part of a restraint system in which the locking web retractor is secured or is securable to a support structure, one end of a web is operatively coupled to the web retractor and a first engagement member is typically coupled to the opposite end of the web for releasably engaging second engagement member such that the web thereby restrains the other some type of body between the web retractor and the releasable engagement member. In some embodiments, the locking web retractor may be mounted in a motor vehicle of any type, without limitation, to at least one frame component thereof and/or to at least one frame component of an occupant seat mounted in the motor vehicle, and the second engagement member may be secured to at least another frame component of the motor vehicle and/or of the occupant seat such that the web, upon engagement of the first and second engagement members, extends at least partially over or about at least a portion of the occupant seat to restrain a person, animal or object occupying the seat.

In other embodiments, the locking web retractor may define or be part of a restraint system for restraining an occupant carried in other types of mobile structures. For purposes of this disclosure, the term “mobile structure” may be understood to mean any of the following examples which include, but are not limited to, aircraft of any type, without limitation, watercraft of any type, without limitation, wheelchairs, personal mobility carts, and towed vehicles including, but not limited to, trailers or the like. In such embodiments, the locking web retractor will typically be mounted to the mobile structure and/or to an occupant seat thereof, and the second engagement member may be likewise secured to the mobile structure and/or to the occupant seat thereof such that the web, upon engagement of the first engagement member with the second engagement member, extends at least partially over or about the occupant seat of the mobile structure to restrain a person, animal or object occupying the seat.

In still other embodiments, the locking web retractor may define or be part of a restraint system for restraining cargo in a motor vehicle or in any type of mobile or stationary structure. In such embodiments, the locking web retractor will typically be mounted to the motor vehicle, mobile structure or stationary structure. In some such embodiments, a second engagement member may be likewise secured to the motor via a mobile structure or stationary structure such that the web, upon engagement of the first engagement member with the second engagement member, extends at least partially over or about the cargo to restrain the cargo relative to the motor vehicle, mobile structure and/or stationary structure. In other such embodiments, the motor vehicle, mobile structure and/or stationary structure may define or include another engagement structure suitable for engagement with the first engagement member such that the web, upon engagement of the first engagement member with the engagement structure of the motor vehicle, mobile structure and/or stationary structure, extends at least partially over or about the cargo to restrain the cargo relative to the motor vehicle, mobile structure and/or stationary structure.

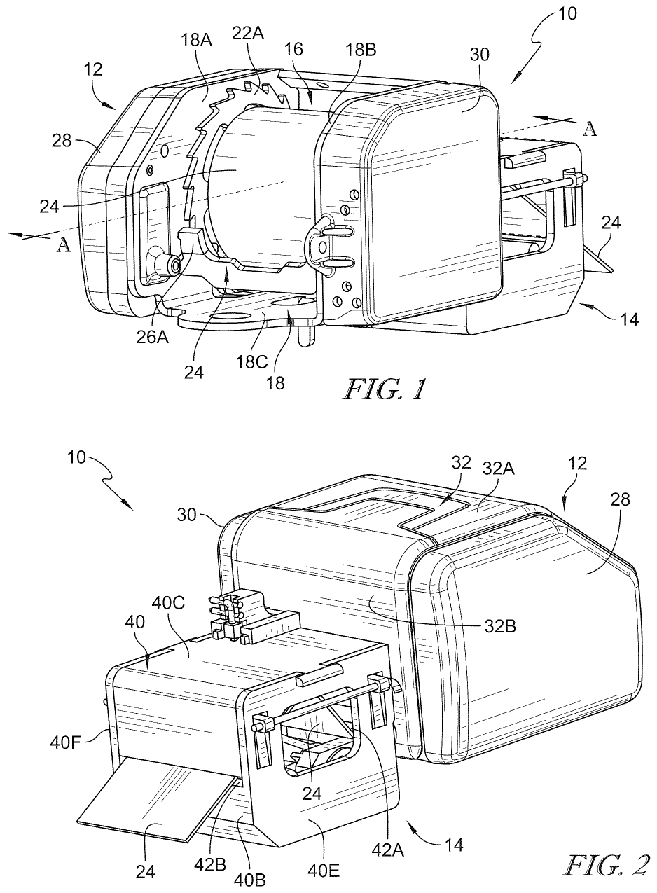

Referring now to FIGS. 1-5, an embodiment is shown of a combination locking web retractor and web attenuator 10, including a locking web retractor 12 and a web attenuator 14 mounted directly to the web retractor 12. In the illustrated embodiment, the web retractor 12 includes a spool assembly 16 rotatably mounted to and between spaced-apart side walls 18A, 18B of a web retractor frame 18. Bottom ends of the side walls 18A, 18B are joined by a bottom wall 18C from which the side walls 18A, 18B extend. In some embodiments, the frame 18 is of unitary construction, although in other embodiments one or both of the side walls 18A, 18B may be separate from the bottom wall 18C and joined thereto during assembly. Illustratively, the locking web retractor 12 is configured to be mounted to a support surface, e.g., within a motor vehicle, with an outer or external surface 18D of the bottom wall 18C in contact with and supported on the support surface.

The spool assembly 16 illustratively includes a spool shaft 20 mounted to and between the side walls 18A, 18B such that the spool shaft 20 rotates relative to the side walls 18A, 18B. A web spool 21 is coupled to the spool shaft 20 such that the web spool rotates with the spool shaft 20, about a central, longitudinal axis of the spool shaft 20, relative to the side walls 18A, 18B of the frame 18. In the illustrated embodiment, at least one toothed wheel or gear 22A is mounted to the spool shaft 20 and/or to the web spool 20 adjacent to the side wall 18A such that the toothed wheel 22A is positioned adjacent to an inwardly-facing surface of the side wall 18A and rotates with the spool shaft 20 and web spool 21 relative to the side walls 18A, 18B. In some embodiments, the spool assembly 16 may include a second toothed wheel mounted adjacent to the opposite side wall 18B. In any case, a conventional flexible or semi-flexible web 24 is wound about the web spool 21 such that the web 24 can be taken up on, i.e., wound onto and about, the web spool 21 as the spool assembly 16 rotates in one direction (hereinafter a “web take up direction”) relative to the side walls 18A, 18B of the frame, and wherein the web 24 is paid off from, i.e., wound off from, the web spool 21 as the spool assembly 16 rotates in a direction opposite the web take up direction (hereinafter a “web payout direction”).

In the illustrated embodiment, as depicted by example in FIG. 1, the locking web retractor 12 includes a lock pawl 26 movably mounted, e.g., rotatably mounted, to and between the side walls 18A, 18B of the frame 18. The lock pawl 26 is movable, e.g., rotatable, relative to the side walls 18A, 18B between a rearward, and unlocked, position, and a forward, and locked, position. The lock pawl 26 illustratively includes at least one engagement tab or ear 26A which is configured to engage the toothed wheel 22A in the locked position of the lock pawl 26 to prevent the toothed wheel 22A, and thus the spool assembly 16, from rotating in the web payout direction while at the same time allowing the spool assembly 16 to rotate in the web take-up direction, and to disengage from the toothed wheel 22A in the unlocked position of the lock pawl 26 to allow the toothed wheel 22A, and thus the spool assembly 16, to rotate in the web payout and web take-up directions, as is conventional. Illustratively, the lock pawl 26 is controlled between the locked and unlocked positions by a locking assembly, e.g., inertia-based, magnetic, mechanical, electro-mechanical, and/or electro-magnetic, or other conventional control mechanism, at least partially housed within and/or covered by a housing 28 coupled to an outer surface of one of the side walls, e.g., the side wall 18A in FIG. 1, of the frame 18, or otherwise mounted to another part or section of the frame 18. In some such embodiments, the locking assembly may engage one end of the spool shaft 20 extending through the side wall 18A such that at least one component of the locking assembly is rotatable with the spool shaft 20 relative to the sidewalls 18A, 18B of the frame 18. In some alternate embodiments, the locking components at least partially housed within and/or covered by the housing 28 may be configured to lock and unlock the spool assembly without the assistance of the lock pawl 26, and in such embodiments the lock pawl 26 may be omitted.

The locking web retractor 12 illustratively includes a conventional power spring assembly including a conventional coiled power spring engaged between one end of the spool shaft 20 and a cover or plate 30 mounted to an outer surface of another one of the side walls, e.g., the side wall 18B in FIG. 1, of the frame 18. The power spring is illustratively configured to engage a respective end of the spool shaft 20 extending through the side wall 18B, and to bias the spool shaft 20 of the spool assembly 16, e.g., relative to the cover or plate 30, to rotate in the web take-up direction. To draw the web 24 from the retractor 12 (without the spool assembly 16 rotationally locked and from a front end of the retractor 12 opposite the lock pawl 26), sufficient force, i.e., tension, must be applied to the web 24 in the web pay-out direction, i.e., out of and away from the retractor 12, to overcome the biasing force of the power spring of the power spring assembly as is conventional.

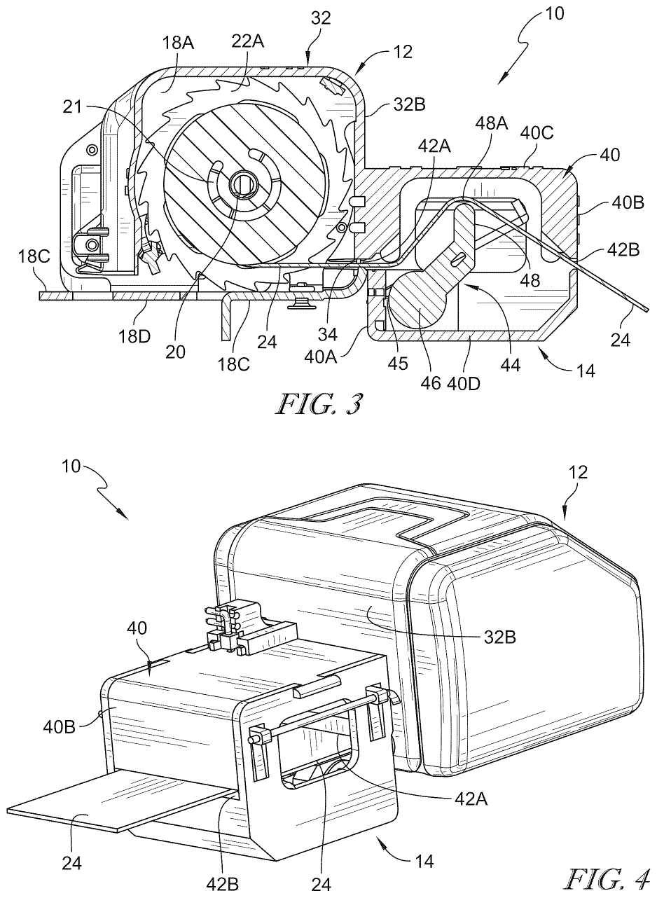

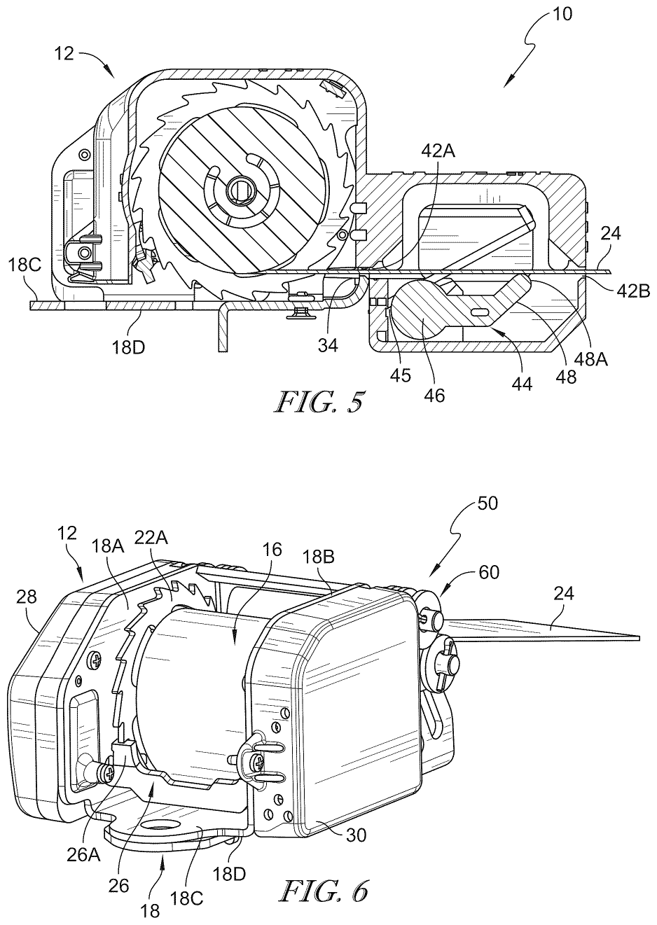

In some embodiments, the retractor 12 is provided with a housing or cover 32 which may illustratively have a top section 32A disposed over the frame 18 at or adjacent to the top edges of the side walls 18A, 18B, and a front section 32B which extends over a front portion of the frame 18 opposite the lock pawl 26, such that the spool assembly 16 is positioned between the lock pawl 26 and the front end of the frame 18 covered by the front section 32B of the housing or cover 32. As depicted by example in FIGS. 3 and 5, the front section 32B of the housing or cover 32 illustratively defines a web exit slot or port 34 just above the upwardly-facing surface of the bottom wall 18C of the frame 18.

In the embodiment illustrated in FIGS. 1-5, the example web attenuator 14 illustratively includes a frame 40 mounted, e.g., attached or otherwise secured, to at least the front section 32B of the housing or cover 32 of the web retractor 12. In the illustrated embodiment, the frame 40 includes a rear wall 40A defining therethrough a web entrance slot or port 42A which is aligned with the web exit slot or port 34 of the housing or cover 32 of the web retractor (see, e.g., FIGS. 3 and 5), and a front wall 40B opposite the rear wall 40A and defining therethrough a web exit slot or port 42B. In the illustrated embodiment, the web ports 34, 42A, and 42B are all axially aligned with one another, although in some alternate embodiments the web exit port 42B may not be axially aligned with the web entrance slot or port 42A. In some embodiments in which the web 24 exits the web retractor 12 via an opposite end of the frame 18, or via a top, bottom, or side of the frame 18, the frame 40 may be configured to be mounted to, or integral with the frame 18 so as to align the web entrance slot or port 42A with a corresponding web exit slot or port of the web retractor 12. In any case, the frame 40 may illustratively include top and bottom walls 40C, 40D coupled to or integral with the front and rear walls 40B, 40A, although in some embodiments the top wall 40C and/or the bottom wall 40D may be omitted. The frame 40 further illustratively includes opposite side walls 40E, 40F coupled to integral with the rear, front, top, and bottom walls 40A-40D. It will be understood that whereas the frame 40 of the web attenuator 14 is illustrated in FIGS. 1-5 and has been described herein as being coupled, i.e., attached or otherwise mounted, to the housing or cover 32 of the web retractor 32, in some alternate embodiments the frame 40 may be coupled directly to the frame 18, and in still other alternate embodiments the frame 40 may be integral with the housing 32 and/or with the frame 18, such that the frame 40 and the housing or cover 32, and/or the frame 40 and frame 18, may be of unitary construction.

Carried within the housing 40 of the web attenuator 14 is a web attenuating member 44 in the form of a web guide having a base 46 rotatably, i.e., pivotably, coupled to and between the side walls 40E, 40F of the frame 40, such that the base 46 is rotatable fore and aft (toward and away from the rear and front walls 40A, 40B respectively) relative to the side walls 40E, 40F of the frame 40. A web guide arm 48 extends away from the web attenuator base 46 and terminates at a web-engaging end or edge 48A, and the web 24 passing through the frame 40 from the web entrance slot 42A to, and through, the web exit slot 42B passes over the web guide arm 48 of the web attenuating member 44. At least one biasing member 45, e.g., at least one conventional spring, is coupled to and between the web guide arm 48 and at least one of the walls 40. 40C, 40D, 40E, and/or 40F, and the biasing member(s) 45 acts to normally bias the web attenuating member 44 such that the base 46 rotates relative to t. side walls 40E, 40F to position the web-engaging end 48A of the web guide arm 48 upwardly away from the axial plane defined between the web entrance and exits slots 42A, 42B respectively, as depicted by example in FIGS. 2 and 3. The web 24 passing through the housing 40 between the web entrance and exit slots 42A, 42B is thus supported on, and displaced by, the web guide arm 48 upwardly and away from the axial plane defined between the web entrance and exits slots 42A, 42B, as the web 24 rides on and over the web-engaging end 48A of the web guide arm 48.

In an unlocked state of the web retractor 12, the biasing force of the biasing member(s) 45 is illustratively greater than frictional forces of the web 24 acting on the web-engaging end 48A of the web guide arm 48, such that the load applied by the web 24 is effective a no load condition. Movement of the web 24 out of and into the web retractor 12, i.e., as the spool assembly 16 rotates in the web payout and take-up directions respectively, therefore will generally not displace, or will only minimally displace, the web attenuating member 44 from the web supporting position illustrated in FIGS. 2 and 3. With the web retractor 12 in a locked position, in contrast, tension applied to the web 24 at a point or points downstream of the web exit 42B of the web attenuator housing 40 will cause the portion of the web 24 riding on the web-engaging end 48A of the web guide arm 48 to act on and against the web attenuating member 44 in a direction opposite to the biasing force of the biasing member(s) 45. If the force of such tension applied to the web 24 exceeds the biasing force of the biasing member(s) 45, the portion of the web 24 riding on the web engaging end 48A of the web guide arm 48 will force the base 46 of the web attenuating member 44 to rotate toward the web exit slot 42B of the housing 40 against the biasing force of the biasing member(s) 45, thereby causing the web-engaging end 48A of the web guide arm 48 to rotate downwardly toward the web exit slot 42B and release an additional, corresponding length of web 24 from the web exit slot 42B.

With sufficient tension applied to the web 24, the force of the web 24 acting on the web guide arm 48 will rotate the web attenuating member 44 to a fully forward position as illustrated by example in FIGS. 4 and 5. In this fully forward position of the web guide arm 48, the force of the tension applied to the web 24 will no longer be acting on the web attenuating member 44 but will rather be acting on and against the locking components of the web retractor 12. In any case, upon sufficient lessening of the tension applied to the web 24, the biasing force of the biasing member(s) 45 acting on the web attenuating member 44 will cause the web guide arm 48 to rotate upwardly, and eventually to the position illustrated in FIGS. 2 and 3. Between the unattenuated position of the web attenuating member 44 illustrated by example in FIGS. 2 and 3 and the fully attenuated position of the web attenuating member 44 illustrated by example in FIGS. 4 and 5, the web attenuating member 44 thus resiliently attenuates movement of the web 24 against the biasing force of the biasing member(s) 45.

Referring now to FIGS. 6-9, another embodiment is shown of a combination locking web retractor and web attenuator 50, including a locking web retractor 12 and a web attenuator 60 mounted directly to the web retractor 12. In the illustrated embodiment, the locking web retractor 12 is the same as the locking web retractor 12 illustrated in FIGS. 1-5 and described above, although in the embodiment illustrated in FIGS. 6-9 the web retractor cover or housing 32 is omitted. All other components of the locking web retractor 12 are as structurally and operatively described above, and like numbers are therefore used in FIGS. 6-9 to identify like components of the locking web retractor 12 illustrated in FIGS. 1-5.

In the embodiment illustrated in FIGS. 6-9, the example web attenuator 60 illustratively includes a frame 62 that is mounted, e.g., attached or otherwise secured, to the frame 18 of the web retractor 12. In the illustrated embodiment, the frame 62 includes spaced-apart side walls 62A, 62B joined along their bottom ends by a bottom wall 62C. An outer, downwardly-facing surface 62D of the bottom wall 62C defines a mounting surface of the frame 62. In some embodiments, the surface 62D of the bottom wall 62C is flush with the surface 18D of the bottom wall 18C of the frame 18 of the locking web retractor 12, and in other embodiments the surface 62D may be offset in either direction from the surface 18D of the bottom wall 18C of the frame 18. In some embodiments, the bottom wall 62C is affixed to the bottom wall 18C of the frame 18 of the locking web retractor 12, and in some alternate embodiments the bottom wall 62C of the web attenuator frame 62 and the bottom wall 18C of the web retractor frame 18 are integral, e.g., of unitary construction, such that the frames 62, 18 are likewise integral and of uniform construction. In some such embodiments, the side wall(s) 62A and/or 62B may likewise be integral with the respective side wall(s) 18A, 18B. In any case, each of the side walls 62A, 62B defines a respective slot or channel 64A, 64B therethrough, each illustratively extending at an acute angle relative to vertical from a respective lower terminal end 64A₁, 64B₁ adjacent to a front end of the frame 62 upwardly to a respective upper terminal end 64A₂, 64B₂ at a mid-portion of the respective side wall 62A, 62B.

A pin or shaft 66 is mounted to and between the side walls 62A, 62A adjacent to or near a top of the side walls 62A, 62B. Opposite ends 67 of the pin or shaft 66 extend through the side walls 62A, 62B, and a pair of guide members 68A, 68B, e.g., in the form of washers or other suitable structures, are secured to the pin or shaft 66 outboard of each side wall 62A, 62B. In embodiments which include it, the pin or shaft 66 is fixed to and between the side walls 62A, 62B. In some embodiments, the pin or shaft 66 may be omitted, and in such embodiments the guide members 68A, 68B may be affixed to the respective side walls 62A, 62B and operable as described below. Opposing ends 71 of a web guide 70, e.g., in the form of another pin or shaft, are received within respective slots 64A, 64B defined through the side walls 62A, 62B, and another pair of guide members 68A, 68B, e.g., in the form of washers or other suitable structures, are secured to the web guide 70 outboard of each side wall 62A, 62B. Another web guide 74, e.g., in the form of a pin or shaft, is mounted to and between the side walls 62A, 62B near the bottom wall 62C. The web guide 74 is illustratively fixed to and between the side walls 62A, 62B. Each of the pins or shafts 66, 70, 74 extend transversely between the two side walls 62A, 62B, with the pins 66 and 74 fixed in position on the side walls 62A, 62B and with the pin 70 movable relative to the side walls 62A, 62B along the slots 64A, 64B. A space 76 is defined between the web guide 74 and the upwardly-facing surface of the bottom wall 62C of the frame 62, another space 78 is defined between the web guides 70 and 74, and yet another space is defined between the pin or shaft 66 (in embodiments which include it) and the web guide 70.

Resilient members 72A, 72B are illustratively coupled between the pin or shaft 66 and the pin or shaft forming the web guide 70 outboard of the sides 62A, 62B of the frame 62, and are illustratively held in place by the guide members 68A, 68B. In some alternate embodiments, the resilient members 72A, 72B may be coupled between the web guide 70 and one or more attachment locations on the frame 18 of the web retractor 12. In any case, the resilient members 72A, 72B illustratively operate to suspend the web guide 70 from the pin or shaft 66 (or from the side walls 62A, 62B of the frame 62, or from one or more locations of the frame 18 of the web retractor 12) such that the web guide 70 is moveable within the slots 64A, 64A in a direction toward the pin or shaft 66 under bias of the resilient members 72A, 72B, and such that the web guide 70 may be moveable within the slots 64A, 64B in a direction away from the pin or shaft 66 (or other fixed mounting location of the resilient members 72A, 72B) against the bias of the resilient members 72A, 72B under a load force applied to the web guide 70 by the web 24 as described below. In the illustrated embodiment, the resilient members 72A, 72B are provided in the form of O-rings or rings of other shapes formed of one or more suitable resilient materials such as rubber, latex, or the like. In some such embodiments, each of the resilient members 72A, 72B may include multiple O-rings. In other embodiments, the resilient members 72A, 72B may be provided in the form of linear, non-linear or piecewise liner shapes of one or more conventional resilient materials. In some such alternate embodiments, the one or more conventional biasing members may be or include one or more conventional springs, e.g., one or more linear or non-linear coil springs, flat springs and/or wire forms embodied as one or more compression springs, one or more extension springs, one or more torsion springs, one or more constant force springs or the like, or any combination thereof. Alternatively or additionally, the one or more biasing members may be or include one or more conventional shock absorbing or shock dampening devices, e.g., such as one or more conventional dashpots, of hydraulic, pneumatic and/or mechanical design. In any case, the one or more biasing members may be selected or designed to have any desired linear or non-linear, constant or non-constant, biasing force(s) to achieve any desired dampening or spring rate.

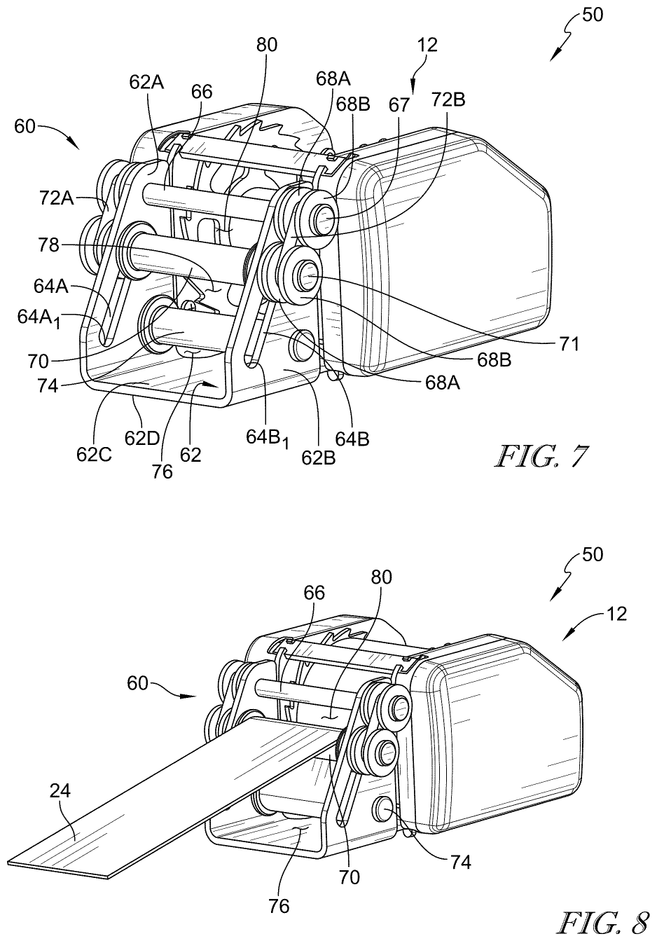

As illustrated in FIG. 8, the web 24 exiting the web retractor extends through the space 76 defined between the web guide 74 and the bottom wall 62C of the frame 62, and then upwardly and back through the space 78 defined between the web guides 70, 74, then upwardly and forwardly over the web guide 70, and then forwardly away from the web attenuator 60. In this regard, the space 76 adjacent to the frame 18 illustratively represents a web entrance of the web attenuator 60, and the upwardly-facing surface of the web guide 70 illustratively represents a web exit of the web attenuator, i.e., an area of the web attenuator 60 through which the web 24 exits the frame 62. In some embodiments in which the web 24 exits the web retractor 12 via an opposite end of the frame 18, or via a top, bottom, or side of the frame 18, the frame 62 may be configured to be mounted to, or integral with the frame 18 so as to align the web entrance space 76 with a corresponding web exit slot or port of the web retractor 12. In any case, the web 24 is thus supported on and by the web guide 70 resiliently suspended from the pin or shaft 66 (or the side walls 62A, 62B of the frame 62) by the resilient members 72A, 72B. In some embodiments, the acute angle defined by the opposed pairs of slots 64A, 64B may be selected to at least approximately match an angle at which the web 24 will exit the web attenuator 60.

The resilient members 72A, 72 operate to resiliently attenuate downward forces, or forces having a downward force component, i.e., in the direction from the top of the web guide 70 downwardly toward the upwardly-facing surface of the bottom wall 62C of the frame 62 of the web attenuator 60, resulting from tension applied to the web 24 at a point or points downstream of the web attenuator 60 as described above with respect to FIGS. 1-6. Illustratively, the resilient force of the of the resilient members 72A, 72B, i.e., the amount of tension required to be applied by the web 24 to the web guide 70 to overcome the resilient force of the resilient members 72A, 72B so as to move the web guide 70 within the slots 64A, 64B in a direction away from the pin or shaft 66, may be selected based on the application, and the resilient members 72A, 72B may thus be sized, designed, and/or selected accordingly. In some embodiments, multiple resilient members 72A, 72B per side may be used to achieve a desired resilient force.

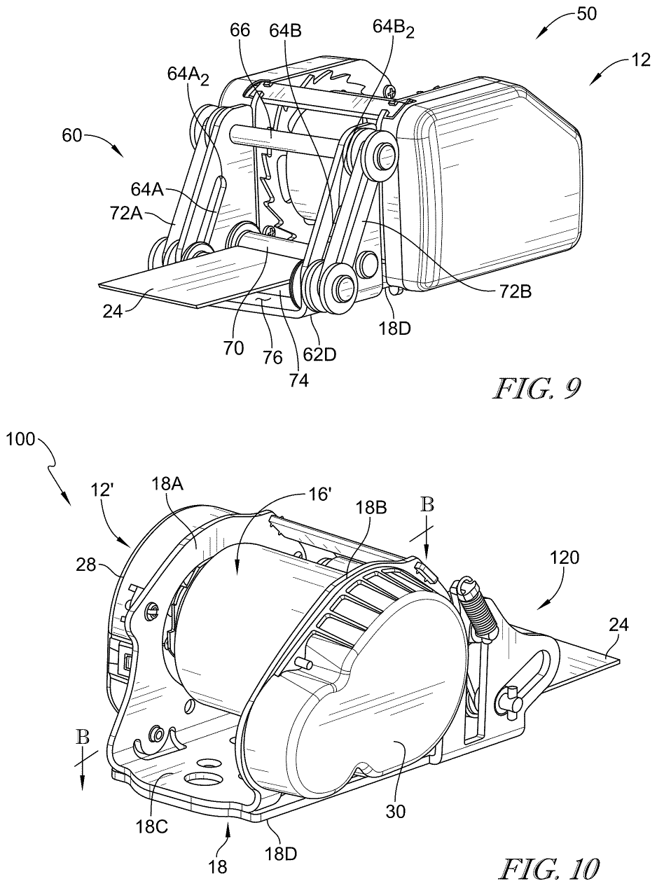

In any case, without tension applied to the web 24, and thus without force applied by the web 24 to the web guide 70, e.g., in an unlocked state of the locking web retractor 12, the biasing force of the resilient members 72A, 72B illustratively pulls the web guide 70 upwardly along the slots 64A, 64B into engagement with the respective upper terminal ends 64A₂, 64B₂, as depicted by example in FIG. 8. With tension applied to the web 24 greater than the biasing force of the resilient members 72A, 72B, and with the locking retractor 12 in a locked state as described above with respect to FIGS. 1-6, the force of the web 24 acting on the web guide 70 will pull the pin or shaft 70 downwardly along the slots 64A, 64B, against the bias of the resilient members 72A, 72B, toward the terminal ends 64A₁, 64B₁ of the respective slots 64A, 64B. With sufficient amount of such tension applied to the web 24, the force of the web 24 acting on the web guide 70 will pull the pin or shaft 70 downwardly along the slots 64A, 64B, against the bias of the resilient members 72A, 72B, into engagement with the lower terminal ends 64A₁, 64B₁ of the respective slots 64A, 64B as illustrated by example in FIG. 9. Upon sufficient lessening of the tension applied to the web 24, the biasing force of the resilient members 72A, 72B acting between the pin or shaft 66 and the web guide 70 will cause the web guide 70 to move back upwardly along the slots 64A, 64B, and eventually into engagement with the upper terminal ends 64A₂, 64B₂ of the slots 64A, 64B as depicted by example in FIG. 8. Between the unattenuated position of the web guide 70 illustrated by example in FIG. 8 and the fully attenuated position of the web guide 70 illustrated by example in FIG. 9, the web guide thus resiliently attenuates movement of the web 24 against the biasing force of the resilient members 72A, 72B relative to the fixed pin or shaft 66.

Referring now to FIGS. 10-16, yet another embodiment is shown of a combination locking web retractor and web attenuator 100, including a locking web retractor 12′ and a web attenuator 120 mounted directly to the web retractor 12′. In the illustrated embodiment, the locking web retractor 12′ is similar to the locking web retractor 12 illustrated in FIGS. 1-9 and described above, although in the embodiment illustrated in FIGS. 10-16 the web retractor cover or housing 32 and the lock pawl 26 are omitted, and a modified spool assembly 16′ omits the toothed wheel(s) 22A, 22B. In the embodiment illustrated in FIGS. 10-16, the locking components are at least partially housed within and/or covered by the housing 28 and are configured, in a conventional manner, to lock and unlock the spool assembly 16′ without the assistance of a lock pawl acting against one or more toothed wheel(s) as described above, and the lock pawl 26 and the toothed wheel(s) 22A, 22B are therefore omitted in this embodiment as just described. All other components of the locking web retractor 12′ are as structurally and operatively described above with respect to FIGS. 1-5, and like numbers are therefore used in FIGS. 10-16 to identify like components of the locking web retractor 12′ illustrated in FIGS. 10-16. In alternate embodiments, the locking web retractor 12 illustrated in FIGS. 1-5 and described above may instead be used in the locking web retractor and web attenuator 100. Alternatively still, in any of the embodiments illustrated in FIGS. 1-16 and described herein, any locking web retractor may be used which has a frame or frame component to attached to or make integral with the web attenuator, which carries a web to be taken up and paid out by and from the web retractor, and which is lockable to prevent pay out of the web.

In the embodiment illustrated in FIGS. 10-16, the example web attenuator 120 illustratively includes a frame 122 that is mounted, e.g., attached or otherwise secured, to the frame 18 of the web retractor 12′. In the illustrated embodiment, the frame 122 includes spaced-apart side walls 122A, 122B joined along their bottom ends by a bottom wall 122C. An outer, downwardly-facing surface 122D of the bottom wall 122C defines a mounting surface of the frame 122. In some embodiments, the surface 122D of the bottom wall 122C is flush with the surface 18D of the bottom wall 18C of the frame 18 of the locking web retractor 12′, and in other embodiments the surface 122D may be offset in either direction from the surface 18D of the bottom wall 18C of the frame 18. In some embodiments, the bottom wall 122C is affixed to the bottom wall 18C of the frame 18 of the locking web retractor 12′, and in some alternate embodiments the bottom wall 122C of the web attenuator frame 122 and the bottom wall 18C of the web retractor frame 18 are integral, e.g., of unitary construction, such that the frames 122, 18 are likewise integral and of uniform construction. In some such embodiments, the side wall(s) 122A and/or 122B may likewise be integral with the respective side wall(s) 18A, 18B of the frame 18, i.e., such that the side walls 122A, 18A and/or the side walls 18B, 122B are of unitary construction. In any case, each of the side walls 122A, 122B defines two respective, opposed slots or channels 124A, 124B and 126A, 126B therethrough. In the illustrated embodiment, the longitudinal axis of the opposed slots or channels 124A, 124B extend vertically, i.e., normal to the plane defined by the bottom wall 18C of the frame 18 of the retractor 12′, between respective upper terminal ends 124A₁, 124B₁ adjacent to a top end of the respective side walls 122A, 122B and respective lower terminal ends 124A₂, 124B₂ adjacent to the upwardly-facing surface of the bottom wall 122C of the frame. The longitudinal axis of the opposed slots or channels 126A, 126B illustratively extend at an acute angle relative to vertical from a respective lower terminal end 126A₁, 126B₁ adjacent to a lower terminal end of a respective one of the slots or channels 124A, 124B, upwardly to a respective upper terminal end 126A₂, 126B₂ adjacent to a front end of the side walls 122A, 122B.

A web guide 128, e.g., in the form of a pin or shaft, is mounted to and between the side walls 122A, 122A with opposed ends 129 received within respective ones of the slots 124A, 124B defined through the side walls 122A, 122B, and another web guide 132, e.g., also in the form of a pin or shaft, is also mounted to and between the side walls 122A, 122B with opposed ends 133 received within respective ones of the slots 126A, 126B defined through the side walls 122A, 122B. The web guide 128 is thus movable along the slots 124A, 124B between the respective terminal ends 124A₁, 124B₁ and 124A₂, 124B₂ thereof, and the web guide 132 is likewise movable along the slots 126A, 126B between the respective terminal ends 126A₁, 126B₁ and 126A₂, 126B₂ thereof. Biasing members 130A, 130B, e.g., a coiled springs, are mounted between respective ends 129 of the web guide 128 and respective side walls 122A, 122B of the frame 122 (and/or to the respective side walls of the frame 18 of the web retractor 12′) so as to bias the web guide 128 toward and into contact with the upper terminal ends 124A₁, 124B₁ of the channels 124A, 124B. The web guide 128 is thus movable downwardly away from the upper terminal ends 124A₁, 124B₁ of the channels 124A, 124B and toward the lower terminal ends 124A₂, 124B₂ of the channels 124A, 124B against the biasing force of the biasing members 130A, 130B. In alternate embodiments, the biasing members 130A, 130B may be provided in the form of polymer O-rings or other suitable biasing members as described above with respect to the embodiment illustrated in FIGS. 1-5.

The web guide 128 and the web guide 132 are rigidly coupled to one another by a connecting frame 134 such that the web guides 128, 132 move together along the respective channels 124A, 124B and 126A, 126B. In the illustrated embodiment, the connecting frame 134 includes a side wall 134A connected to and between the web guides 128, 132 adjacent to the side wall 122A of the frame 122, another side wall 134B connected to and between the web guides 128, 132 adjacent to the other side wall 122B of the frame 122, and a connecting member 134C connected to and between the side walls 134A, 134B between the web guides 128, 132.

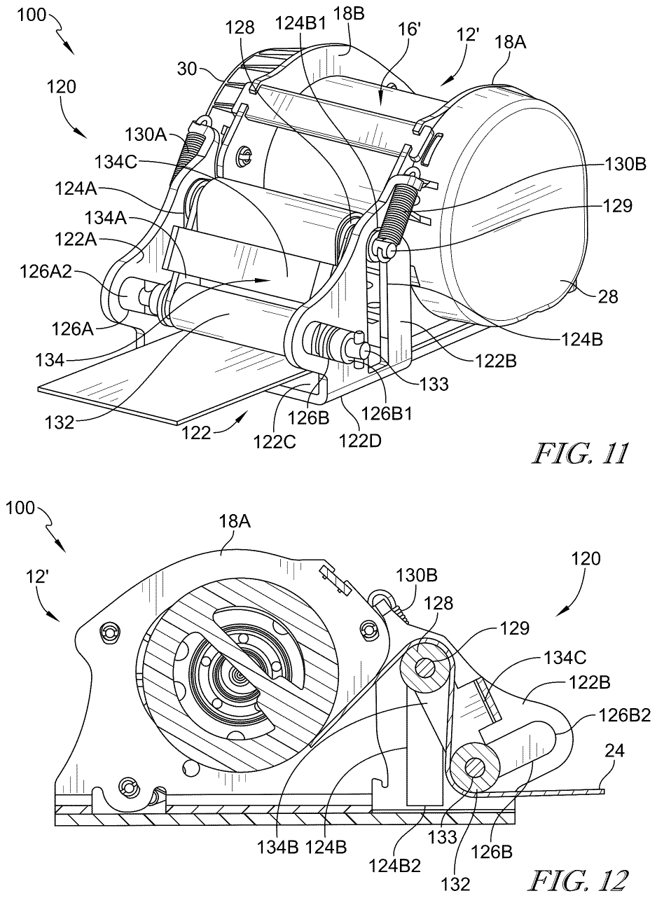

As best shown in FIGS. 12, 14 and 16, the web 24 exiting the web retractor 12′ extends upwardly and over the web guide 128, then downwardly and under the web guide 132, and then outwardly away from the web attenuator 120. In this regard, the space between the frame 18 of the web retractor 12′ and the web guide 128 illustratively represents a web entrance of the web attenuator 120, and the space between the downwardly-facing surface of the web guide 132 and the upwardly-facing surface of the bottom wall 122C of the frame 122 illustratively represents a web exit of the web attenuator 120, i.e., an area of the web attenuator 120 through which the web 24 exits the frame 120 (see, e.g., FIG. 12). In some embodiments in which the web 24 exits the web retractor 12′ via an opposite end of the frame 18, or via a top, bottom, or side of the frame 18, the frame 122 may be configured to be mounted to, or integral with the frame 18 so as to align the web entrance space of the web attenuator 120 with a corresponding web exit slot or port of the web retractor 12′. In any case, the biasing members 130A, 130B operate to attenuate downward forces, or forces having a downward force component, i.e., in the direction from the top of the web guide 128 downwardly toward the upwardly-facing surface of the bottom wall 122C of the frame 122 of the web attenuator 120, resulting from tension applied to the web 24 at a point or points downstream of the web attenuator 120 as described above with respect to FIGS. 1-6. Illustratively, the biasing force of the of the biasing members 130A, 130B, i.e., the amount of tension required to be applied by the web 24 to the web guide 128 to overcome the biasing force of the biasing members 130A, 130B so as to move the web guide 128 within the slots 124A, 124B in a direction away from the upper terminal ends 124A₁, 124B₁ of the slots 124A, 124B and toward the lower terminal ends 124A₂, 124B₂ of the slots 124A, 124B (and therefore to also move the web guide 132 away from the terminal ends 126A₁, 126B₁ of the slots 126A, 126B and toward the terminal ends 126A₂, 126B₂ of the slots 126A, 126B), may be selected based on the application, and the biasing members 130A, 130B may thus be sized, designed, and/or selected accordingly. In some embodiments, the biasing members 130A, 130B may alternatively or additionally be attached between the ends 133 of the shaft or pin 132 and the side walls 122A, 122B of the frame 122 and/or the side walls 18A, 18B of the frame 18 of the web retractor 12′.

In any case, without tension applied to the web 24, and thus without force applied by the web 24 to the web guide 128 or to the web guide 132, e.g., in an unlocked state of the locking web retractor 12′, the biasing force of the biasing members 130A, 130B illustratively pulls the web guide 128 upwardly along the slots 124A, 124B and into engagement with the respective upper terminal ends 124A₁, 124B₁, and simultaneously, i.e., due to the connecting frame 134, pulls the web guide 132 rearwardly along the slots 126A, 126B and into engagement with the respective lower terminal ends 126A₁, 126B₁, as depicted by example in FIGS. 11 and 12.

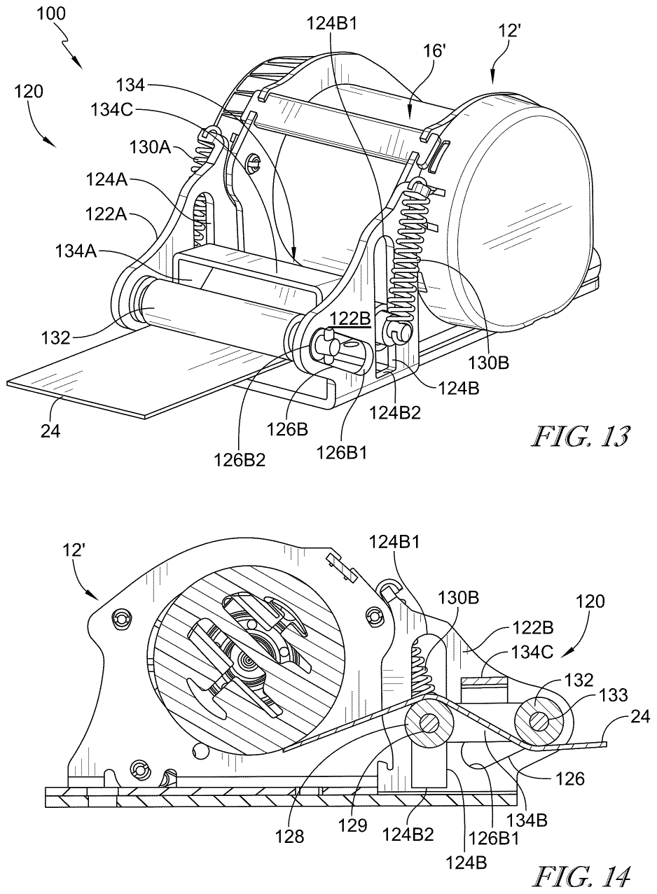

With tension applied to the web 24 greater than the biasing force of the biasing members 130A, 130B, and with the locking retractor 12′ in a locked state as described above with respect to FIGS. 1-6, the force of the web 24 acting downwardly on the web guide 128 will force the web guide 128 downwardly along the slots 124A, 124B, against the bias of the biasing members 130A, 130B, toward the lower terminal ends 124A₂, 124B₂ of the respective slots 124A, 124B while also simultaneously forcing, via the connecting frame 134, the web guide 132 forwardly along the slots 126A, 126B toward the upper terminal ends 126A₂, 126B₂ of the respective slots 126A, 126B. FIGS. 13 and 14 illustrate example positions of the web guides 128, 132 within the respective slots 124A, 124B and 126A, 126B with the web attenuator 120 partially loaded under a respective load force applied to the web 24. In this example, a sufficient amount of load or force applied by the web 24 to the web guide 128 (i.e., that is between the no-load condition illustrated in FIGS. 11 and 12 and a full-load, or fully attenuated, condition described above) has forced the web guide 128 sufficiently downwardly within the slots 124A, 124B between the respective terminal ends 124A₁, 124B₁ and 124A₂, 124B₂ so as to force the web guide 132, via the connecting frame 134, just into contact with the upper terminal ends 126A₂, 126B₂ of the respective slots 126A, 126B. In this position, the side walls 134A, 134B of the connecting frame 134 are illustratively parallel, or at least substantially so, with the plane formed by the upwardly-facing surface of the bottom wall 122C of the web attenuator frame 122, as illustrated by example in FIG. 14.

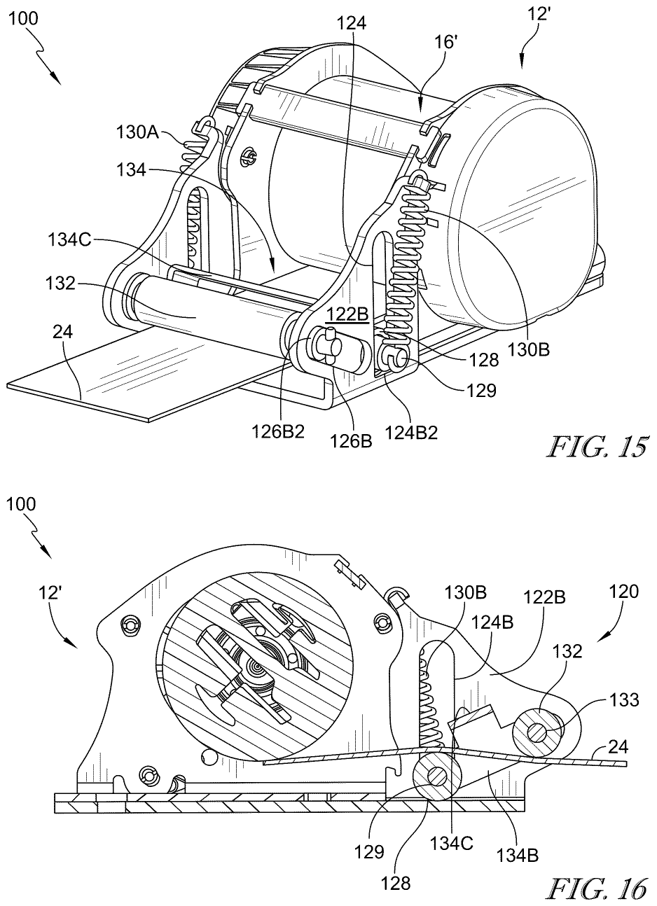

With a sufficient amount of tension applied to the web 24 that is greater than the amount illustrated in FIGS. 13 and 14, the force of the web 24 acting on the web guide will force the web guide 128 further downwardly along the slots 124A, 124B, against the bias of the biasing members 130A, 130B, and eventually into contact with the lower terminal ends 124A₂, 124B₂ of the respective slots 124A, 124B, as illustrated by example in FIGS. 15 and 16. With the web guide 132 already in contact with the upper terminal ends upper terminal ends 126A₂, 126B₂ of the slots 126A, 126B (which occurred at some point as the web guide 128 was being forced toward, but not into contact with, the lower terminal ends 124A₂, 124B₂ of the respective slots 124A, 124B as illustrated by example in FIGS. 13 and 14), forcing the web guide 128 further downwardly and into contact with the lower terminal ends 124A₂, 124B₂ of the respective slots 124A, 124B causes the respective end of the connecting frame 134 to pivot downwardly so as to maintain the web guide 132 in contact with the upper terminal ends 126A₂, 126B₂ of the slots 126A, 126B, as best seen in FIG. 16. In this fully loaded, or fully attenuated, state of the web attenuator 120, the web 24 has moved the web guides 128, 132 to corresponding fully loaded, or fully attenuated, positions in which the load on the web 24, under the loading force applied thereto, is no longer supported on and by either web guide 128, 132, but is rather borne entirely by the web retractor 12′ as also depicted by example in FIG. 16. This feature is illustratively common to all of the embodiments described herein, as further depicted by example in FIGS. 5 and 9.

From the fully loaded or fully attenuated positions of the web guides 128, 132, sufficient lessening of the tension applied to the web 24 will cause the biasing force of the biasing members 130A, 130B acting on the web guide 128 to move the web guide 128 back upwardly along the slots 124A, 124B, which will also cause the web guide 132 to move back downwardly along the slots 126A, 126B after the upward movement of the web guide 128 clears the upper terminal ends 126A₂, 126B₂ of the slots 126A, 126B (see FIGS. 13 and 14). Further upward movement of the web guide along the slots 124A, 124B will cause the web guide 128 to eventually come into contact with the upper terminal ends 124A₁, 124B₁ of the slots 124A, 124B and the web guide 132, via the connecting frame 134, to likewise come into contact with the lower terminal ends 126A₁, 126B₁ of the slots 126A, 126B, as depicted by example in FIGS. 11 and 12. Between the unattenuated position of the web guides 128, 132 illustrated by example in FIGS. 11 and 12 and the fully attenuated position of the web guides 128, 132 illustrated by example in FIGS. 15 and 16, the web guides 128, 132 thus resiliently attenuate movement of the web 24 against the biasing force of the biasing members 130A, 130B relative to the frame 122 of the web attenuator 120.

In some example implementations of the combination locking web retractor and web attenuator illustrated in the attached figures and described above, the combination locking web retractor and web attenuator may be mounted in a motor vehicle as described briefly above. In such implementation, the one or more biasing members or resilient members operate to attenuate load forces applied by the web 24 to the web attenuator under dynamic operating conditions of the motor vehicle which cause the locking web retractor to at least temporarily lock. Under such dynamic operating conditions, typically caused by the terrain being traversed by the motor vehicle, an impact of the motor vehicle with another object, or simply by erratic movement of an occupant of the motor vehicle, may cause a load force to be applied by the web 24 to the one or more resiliently biased pins or shafts of the web attenuator to cause the one or more movable web guides of the web attenuator to move against the biasing force of the one or more biasing or resilient members as described above. Between the unattenuated and fully attenuated positions or states of the web attenuator, as illustrated in the attached figures and described herein, such dynamic operating conditions may cause the web 24 to exert various forces on the resiliently biased web guides which will temporarily cause the biasing or resilient members to temporarily elastically deform, e.g., stretch or otherwise elongate, but to then return to their static positions once the dynamic operating condition has passed. The biasing force applied by the biasing or resilient members to the movable web guide(s) of the web attenuator thus acts to resiliently attenuate forceful, typically downward, movement of the web 24, thereby absorbing at least some amount of the dynamic load force applied by the web 24 during various dynamic operating conditions of the motor vehicle.

While this disclosure has been illustrated and described in detail in the foregoing drawings and description, the same is to be considered as illustrative and not restrictive in character, it being understood that only illustrative embodiments thereof have been shown and described and that all changes and modifications that come within the spirit of this disclosure are desired to be protected.

What is claimed is:

1. A combination locking web retractor and web attenuator, comprising:
a locking web retractor including a first frame, a web, means for taking up and paying out web from the first frame, and means for locking the web retractor to prevent pay out of the web from the first frame, and
a web attenuator including:
a second frame mounted to or integral with the first frame, the second frame defining a web entrance configured to receive the web from the locking web retractor and a web exit through which the web exits the second frame,
a first web guide carried by, and movable relative to, the second frame, the first web guide configured to support the web between the web entrance and the web exit, and
at least one biasing member coupled between the first web guide and at least one of the first or second frame, the at least one biasing member configured to apply a biasing force to the first web guide opposite a load force applied by the web to the first web guide with the web retractor locked so as to resiliently attenuate the load force applied by the web to the first web guide.

2. The combination locking web retractor and web attenuator of claim 1, wherein the first web guide includes a base rotatably mounted to the second frame and a web guide arm supporting the web,
and wherein the at least one biasing member is configured to rotate the base of the first web guide to move the web guide arm to a first position under no load force applied by the web to the first web guide, and wherein the base of first web guide rotates the web guide arm away from the first position against the biasing force of the at least one biasing member in response to the load force applied by the web to the web guide arm of the first web guide.

3. The combination locking web retractor and web attenuator of claim 1, wherein the second frame defines first and second side walls opposite one another, wherein each of the first and second side walls define slots therethrough, and wherein first and second ends of the first web guide are received within the slots defined through the respective side walls such that the first web guide is movable along the slots.

4. The combination locking web retractor and web attenuator of claim 3, wherein the slots defined through the first and second side walls extend downwardly at an acute angle away from a coupling of the at least one biasing member to the first or second frame.

5. The combination locking web retractor and web attenuator of claim 3, wherein the at least one biasing member includes at least a first biasing member coupled to and between the first end of the first web guide and the first or second frame, and at least a second biasing member coupled to and between the second end of the web guide and the first or second frame.

6. The combination locking web retractor and web attenuator of claim 5, wherein the at least a first biasing member and the at least a second biasing member are resilient rings or springs.

7. The combination locking web retractor and web attenuator of claim 5, wherein the web attenuator includes a second web guide fixed to the second frame, wherein the web entrance of the second frame is defined between the second web guide and a bottom wall of the second frame, wherein the web extends through the web entrance, then over the first web guide, and wherein a top surface of the first web guide defines the web exit of the second frame such that the first web guide resiliently attenuates the load force applied by the web to the first web guide against the biasing force of the at least a first biasing member and the biasing force of the at least the second biasing member.

8. The combination locking web retractor and web attenuator of claim 1, wherein the web attenuator includes a second web guide fixed to the second frame, wherein the web entrance of the second frame is defined between the second web guide and a bottom wall of the second frame, wherein the web extends through the web entrance, then over the first web guide, and wherein a top surface of the first web guide defines the web exit of the second frame such that the first web guide resiliently attenuates the load force applied by the web to the first web guide against the biasing force of the at least one biasing member.

9. The combination locking web retractor and web attenuator of claim 3, wherein the slots defined through the first and second side walls extend vertically downwardly from a coupling of the at least one biasing member toward a base of the first or second frame.

10. The combination locking web retractor and web attenuator of claim 3, wherein the at least one biasing member includes at least a first biasing member coupled to and between the first end of the first web guide and the first or second frame, and at least a second biasing member coupled to and between the second end of the web guide and the first or second frame.

11. The combination locking web retractor and web attenuator of claim 10, wherein the at least a first biasing member and the at least a second biasing member are resilient rings or springs.

12. The combination locking web retractor and web attenuator of claim 11, wherein the web attenuator includes a second web guide movable relative to the second frame, wherein the web entrance of the second frame is defined by a top surface of the first web guide, and the web exit of the second frame is defined between the second web guide and a bottom wall of the second frame, wherein the web extends through the web entrance, then over the first web guide, then under the second web guide, and then through the web exit of the second frame, and wherein the first web guide and the second web guide together resiliently attenuate the load force applied by the web to the first web guide against the biasing force of the at least a first biasing member and the biasing force of the at least the second biasing member.

13. The combination locking web retractor and web attenuator of claim 9, wherein the web attenuator includes a second web guide carried by, and movable relative to, the second frame, the second web guide configured to support the web between the web entrance and the web exit.

14. The combination locking web retractor and web attenuator of claim 13, wherein the slots defined through the respective side walls receiving respective ends of the first web guide define first and second slots respectively such that the first web guide is movable along the first and second slots,
and wherein each of the first and second side walls define third and fourth slots therethrough, and wherein first and second ends of the second web guide are received within the third and fourth slots defined through the respective side walls such that the second web guide is movable along the third and fourth slots.

15. The combination web retractor and web attenuator of claim 14, wherein the third and fourth slots defined through the first and second side walls extend upwardly at an acute angle away from a bottom wall of wall of the second frame.

16. The combination web retractor and web attenuator of claim 15, wherein the web entrance of the second frame is defined by a top surface of the first web guide, and the web exit of the second frame is defined between the second web guide and the bottom wall of the second frame, wherein the web extends through the web entrance, then over the first web guide, then under the second web guide, and then through the web exit of the second frame, and wherein the first web guide and the second web guide together resiliently attenuate the load force applied by the web to the first web guide against the biasing force of the at least a first biasing member and the biasing force of the at least the second biasing member.

17. The combination web retractor and web attenuator of claim 16, wherein, in fully attenuated positions of the first and second web guides relative to the second frame, the first and second web guides no longer support the web and the load force on the web is borne entirely by the web retractor.

18. A combination locking web retractor and web attenuator, comprising:
a locking web retractor including a first frame, a web, means for taking up and paying out web from the first frame, and means for locking the web retractor to prevent pay out of the web from the first frame, and
a web attenuator including:
a second frame mounted to or integral with the first frame, the second frame receiving the web from the locking web retractor and defining a web exit through which the web exits the second frame,
first and second web guides coupled to one another and carried by the second frame such that the first and second web guides are movable together relative to, the second frame, the first and second web guides each configured to support the web between the web entrance and the web exit, and
at least one biasing member coupled between the first web guide and at least one of the first or second frame, the at least one biasing member configured to apply a biasing force to the first and second webs guide opposite a load force applied by the web to the first web guide with the web retractor locked so as to resiliently attenuate the load force applied by the web to the first and second web guides.

19. The combination web retractor and web attenuator of claim 18, wherein each of the first and second side walls define first, second, third and fourth slots therethrough, and wherein first and second ends of the first web guide are received within the first and second slots defined through the respective side walls such that the first web guide is movable along the first and second slots, and wherein first and second ends of the second web guide are received within the third and fourth slots defined through the respective side walls such that the second web guide is movable along the third and fourth slots.

20. The combination web retractor and web attenuator of claim 19, wherein the web is received from the web retractor by a top surface of the first web guide, and the web exit of the second frame is defined between the second web guide and the bottom wall of the second frame, wherein the web extends from the web retractor on and over the first web guide, then under the second web guide, and then through the web exit of the second frame, and wherein the first web guide and the second web guide together resiliently attenuate the load force applied by the web to the first web guide against the biasing force of the at one biasing member.
